(19) United States
(12) Patent Application Publication
(10) Pub. No.: US 2024/0402995 A1
(43) Pub. Date: Dec. 5, 2024

(54) DATA PROCESSING APPARATUS, DATA PROCESSING METHOD, AND STORAGE MEDIUM

(71) Applicant: CANON KABUSHIKI KAISHA, Tokyo (JP)

(72) Inventors: MOTOKI YOSHINAGA, Kanagawa (JP); MASAMI KATO, Kanagawa (JP)

(21) Appl. No.: 18/731,777

(22) Filed: Jun. 3, 2024

(30) Foreign Application Priority Data
Jun. 5, 2023 (JP) 2023-092414

(51) Int. Cl. G06F 7/544

(52) U.S. Cl. CPC G06F 7/5443

(57) ABSTRACT

A data processing apparatus includes a multiply-accumulate operation unit configured to perform multiply-accumulate operation on data based on a given multiply-accumulate operation parameter, an arithmetic operation result retention unit configured to retain an arithmetic operation result obtained by the multiply-accumulate operation unit, a command processing unit configured to, based on a given command, perform processing defined by the command on the arithmetic operation result retained by the arithmetic operation result retention unit, and a distribution unit configured to receive a parameter sequence obtained by a combination of the multiply-accumulate operation parameter and the command and configured to, based on a content and sequential order of the combination, give the multiply-accumulate operation parameter to the multiply-accumulate operation unit and give the command to the command processing unit.

### BACKGROUND

### Field of the Disclosure

Aspects of the present disclosure generally relate to a data processing apparatus, a data processing method, and a storage medium, each of which is configured to perform processing for a plurality of types of neural networks.

### Description of the Related Art

A hardware implementation technique for mounting a neural network (hereinafter referred to as an “NN”) in an apparatus with less resource consumption is being demanded.

The NN is known as a method for use in deep learning and is widely used for recognition processing. For example, a convolutional neural network (hereinafter referred to as a “CNN”), which is a type of NN, provides superior performance mainly in a task such as image recognition. The major portion of the NN is configured with multiply-accumulate operation (product-sum operation), and is likely to receive the benefits of parallel processing which is performed by dedicated hardware. Moreover, the NN is compatible with various recognition processing operations only by switching around weight coefficients, i.e., input parameters. Being capable of providing the performance in various recognition processing operations on the same hardware is one of the advantages of the NN.

For example, in a certain processing operation, the NN calculates at what position in an input image a desired subject is present.

Thus, the certain processing operation is processing for receiving an input image as an input and returning the position coordinates in the input image of the subject.

In the above-mentioned recognition processing operation, first, the input image is given to the NN to extract feature data therefrom. The feature data is, for example, two-dimensional data as with the input image, and the NN is preliminarily given weight coefficients in such a way as to be able to output feature data compatible with the purpose of the recognition processing operation. For example, the NN for the above-mentioned recognition processing operation outputs feature data which is large in value with respect to positions near the subject and is small in value with respect to the other positions. Alternatively, in a case where the NN is compatible with a plurality of types of subjects, the NN outputs, as feature data, three-dimensional data obtained by stacking a plurality of pieces of two-dimensional data such as that mentioned above. Each of pieces of two-dimensional data constituting such three-dimensional feature data is referred to as a “channel”.

In the above-mentioned recognition processing operation, next, the NN calculates the position coordinates of a subject from the feature data. Since the feature data becomes larger in value with respect to the same position as the position of the subject in the input image, for example, calculating the position with respect to which the value becomes largest or maximum in the two-dimensional feature data enables estimating the position coordinates of the subject.

In a case where the feature data is three-dimensional, the NN refers to channels associated with the subject the position of which is to be calculated, and performs processing similar to that to be performed in the case of two-dimensional data.

As mentioned above, generally, the recognition processing can fall roughly into a front stage portion for performing arithmetic operation in the NN and a rear stage portion for obtaining a final recognition processing result using an arithmetic operation result obtained by the NN. In the following description, the front stage portion is referred to as a “multiply-accumulate operation portion” and the rear stage portion is referred to as a “post-processing portion”.

On the other hand, there occurs an issue in an increase in the program size or circuit size due to the diversification of recognition processing using an NN. For example, in the recognition processing using an NN, for example, the optimum number of layers of the NN or the optimum number of dimensions for each layer varies according to purposes or recognition targets. Accordingly, as hardware becomes compatible with a greater diversity of recognition processing operations, the sequence for a control unit becomes more complicated, thus leading to an increase in the program size or circuit size.

Japanese Patent Application Laid-Open No. 2020-140546 discusses a data processing apparatus which gives, as an external input, a processing sequence for hardware which performs NN arithmetic operation. The data processing apparatus discussed in Japanese Patent Application Laid-Open No. 2020-140546 gives, as an external input, a plurality of interconnected pieces of control data. Each piece of control data corresponds to one unit of processing obtained by dividing an NN arithmetic processing operation, and the alignment sequence of the pieces of control data represents the sequential order of processing operations. This enables performing a new recognition processing operation by changing over the pieces of control data without adding a new sequence to the data processing apparatus.

U.S. Pat. No. 9,836,691 discusses a data processing apparatus which gives, as an external input, a processing sequence for hardware which performs NN arithmetic operation. The data processing apparatus discussed in U.S. Pat. No. 9,836,691 performs various arithmetic processing operations constituting NN arithmetic operation based on instructions. Combining a plurality of instructions implements desired NN arithmetic operation, and the sequential order for giving instructions represents the sequential order of processing operations. This enables performing a new recognition processing operation by changing over the sequence of instructions without adding a new sequence to the data processing apparatus.

Japanese Patent Application Laid-Open No. 2022-66974 discusses an NN model generation apparatus which generates software according to types of recognition processing operations. The NN model apparatus generation apparatus discussed in Japanese Patent Application Laid-Open No. 2022-66974 gives information about hardware and information about an algorithm, thus generating software having a sequence required for performing desired NN arithmetic operation. Thus, the NN model generation apparatus selectively uses different pieces of software depending on the types of recognition processing operations. This limits sequences which are to be mounted in one piece of software and prevents an increase in the program size.

On the other hand, the method of giving, as an external input, a sequence for an NN arithmetic operation portion as discussed in Japanese Patent Application Laid-Open No. 2020-140546 and U.S. Pat. No. 9,836,691 is not able to prevent or reduce an increase in the program size or circuit size due to the diversification of the post-processing portion of recognition processing. The method of giving, as an external input, a sequence for only the multiply-accumulate operation portion necessitates implementing the multiply-accumulate operation portion with separate software or dedicated hardware. Accordingly, such a method is not able to prevent or reduce an increase in the program size or circuit size.

Moreover, the method of generating software for each type of recognition processing as discussed in Japanese Patent Application Laid-Open No. 2022-66974 is able to prevent or reduce an increase in the program size of each one type of recognition processing, but is burdened with overhead such as a processing time required for rewriting of a program each time switching of recognition processing operations is performed. Accordingly, the condition under which a plurality of types of recognition processing operations is able to be supported by one piece of hardware is only such a limited condition that real time is not required or there is room for memory bus bandwidth.

### SUMMARY

According to an aspect of the present disclosure, a data processing apparatus includes a multiply-accumulate operation unit configured to perform multiply-accumulate operation on data based on a given multiply-accumulate operation parameter, an arithmetic operation result retention unit configured to retain an arithmetic operation result obtained by the multiply-accumulate operation unit, a command processing unit configured to, based on a given command, perform processing defined by the command on the arithmetic operation result retained by the arithmetic operation result retention unit, and a distribution unit configured to receive a parameter sequence obtained by a combination of the multiply-accumulate operation parameter and the command and configured to, based on a content and sequential order of the combination, give the multiply-accumulate operation parameter to the multiply-accumulate operation unit and give the command to the command processing unit.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of a recognition processing unit according to one or more aspects of the present disclosure.

FIG. 2 is a diagram illustrating a configuration of recognition processing which serves as a target for execution according to one or more aspects of the present disclosure.

FIG. 3 is a flowchart illustrating an example of processing for performing post-processing operations which are different for respective recognition processing operations.

FIG. 4 is a diagram illustrating a configuration example of a data processing apparatus according to one or more aspects of the present disclosure.

FIG. 5 is a flowchart illustrating an example of processing which a command processing unit according to one or more aspects of the present disclosure.

FIG. 6 is a diagram illustrating a difference in program size between the flowcharts illustrated in FIG. 3 and FIG. 5.

FIG. 7 is a diagram illustrating configurations of parameters serving as input data according to one or more aspects of the present disclosure.

FIG. 8 is a diagram illustrating a memory map in a recognition processing unit according to one or more aspects of the present disclosure.

FIG. 9 is a diagram illustrating an operation sequence in the recognition processing unit according to one or more aspects of the present disclosure.

FIG. 10 is a diagram illustrating a configuration of recognition processing which serves as a target for execution according to one or more aspects of the present disclosure.

FIG. 11 is a flowchart illustrating an example of processing which a command processing unit performs according to one or more aspects of the present disclosure.

FIG. 12 is a diagram illustrating configurations of parameters serving as input data according to one or more aspects of the present disclosure.

FIG. 13 is a diagram illustrating a memory map in a recognition processing unit according to one or more aspects of the present disclosure.

FIGS. 14A and 14B are diagrams illustrating an operation sequence in the recognition processing unit according to one or more aspects of the present disclosure.

### DESCRIPTION OF THE EMBODIMENTS

Various exemplary embodiments, features, and aspects of the disclosure will be described in detail below with reference to the drawings. Furthermore, configurations described in the following exemplary embodiments are representative examples, and the scope of the disclosure is not necessarily limited to such specific configurations.

Each exemplary embodiment is configured to receive a sequence for the entire recognition processing including a multiply-accumulate operation portion and a post-processing portion as a parameter sequence (hereinafter also referred to simply as “parameters”) in which parameters for respective processing operations are arranged and perform processing according to the content of the parameter sequence. This meets the diversification of sequences for recognition processing while preventing or reducing an increase in the program size or circuit size.

In a data processing apparatus which is described below, a sequence in which a parameter for controlling the multiply-accumulate operation portion and a parameter for controlling the post-processing portion are interconnected is given as an input, and the alignment sequence of parameters serves as a processing order on sequences for the multiply-accumulate operation portion and the post-processing portion. In the exemplary embodiments, what parameters to give to implement intended recognition processing and what processing the data processing apparatus performs on such parameters are described respectively.

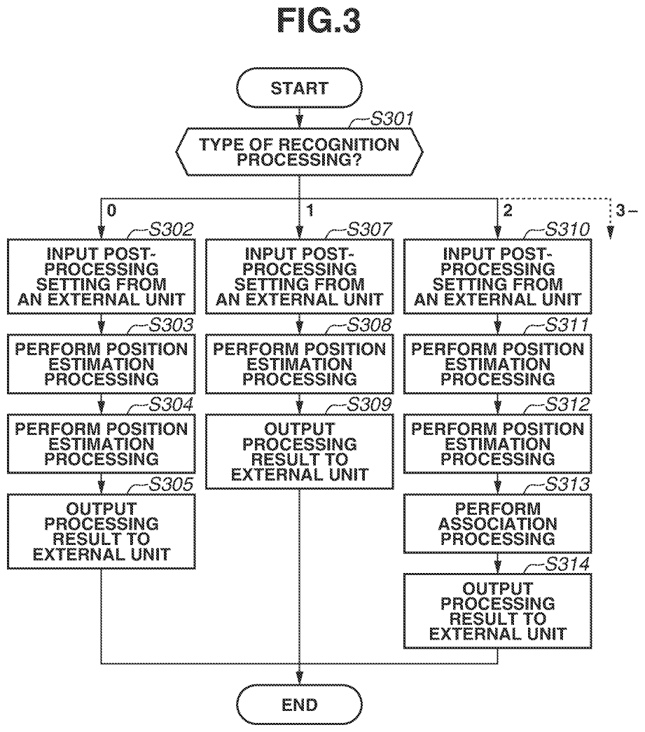

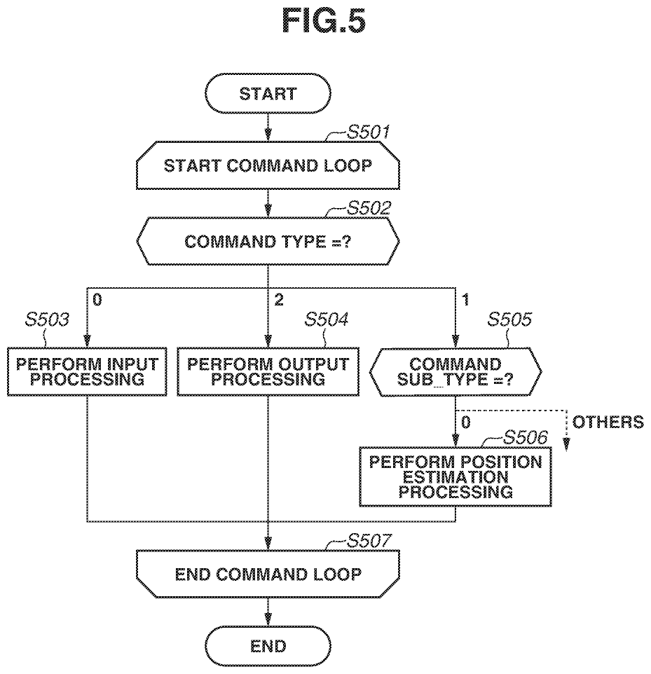

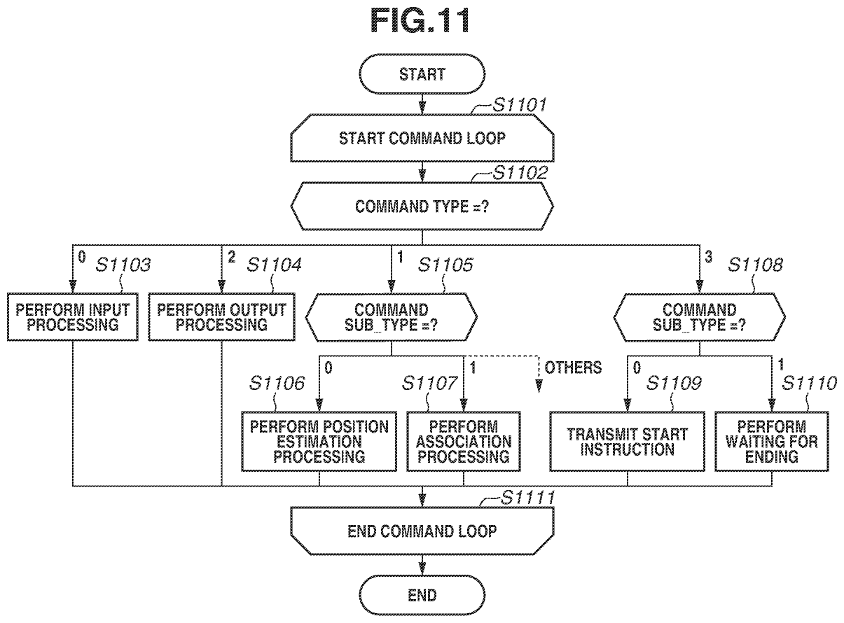

Furthermore, in the following exemplary embodiments, for sake of simplicity, portions equivalent to the flowcharts of FIG. 3, FIG. 5, and FIG. 11 are implemented as software, and it is assumed that the purpose of the data processing apparatus in the exemplary embodiments is to prevent an increase in the program size. In a case where the portions concerned are implemented with hardware, it is similarly possible to prevent an increase in the circuit size.

In a first exemplary embodiment, in a data processing apparatus, appropriate parameters are given to implement a post-processing portion for intended recognition processing. Moreover, the definition of a sequence by the parameters and the configurations of a data processing apparatus and a data processing method required for implementing the sequence are described. Thus, the data processing apparatus according to the first exemplary embodiment implements preventing an increase in the program size caused by the diversification of recognition processing operations.

### Post-Processing and Diversification in Sequence

First, as a premise for the data processing apparatus to be described in the first exemplary embodiment, examples of recognition processing and a multiply-accumulate operation portion and a post-processing portion which are included in the recognition processing are described. Moreover, taking this into account, how to implement a sequence for the post-processing portion and, in that case, what problem occurs from the viewpoint of the program size are described.

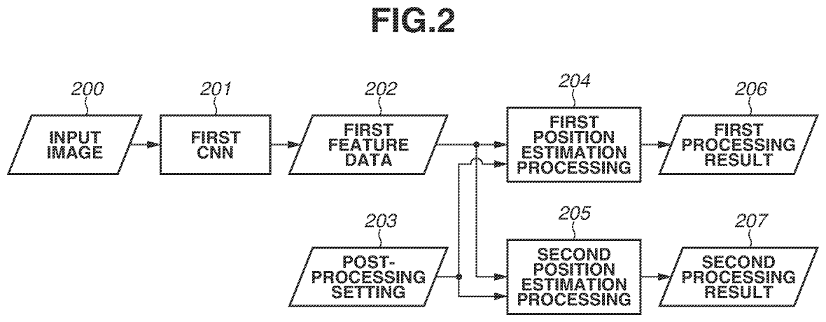

FIG. 2 illustrates a configuration of recognition processing targeted for execution in the first exemplary embodiment. The recognition processing illustrated in FIG. 2 is configured with one convolutional neural network (CNN) and two post-processing operations which use the output of the CNN. This recognition processing is configured to receive an input image 200 and post-processing setting 203 and then return a first processing result 206 and a second processing result 207.

The first CNN 201 receives the input image 200 and performs multiply-accumulate operation on the input image 200. The first CNN 201 returns first feature data 202 as a result of multiply-accumulate operation. The first feature data 202 is a plurality of score maps representing the scores of positions corresponding to the input image 200. Hereinafter, each of the score maps is referred to as a “channel”.

The first CNN 201 is preliminarily trained in such a way as to output a high score with respect to a region in which a specific subject is shown in the input image 200. For example, in a certain channel, the score becomes high with respect to a region in which the head portion of a person is shown, and, in a different channel, the score becomes high with respect to a region in which the body portion of a person is shown.

First position estimation processing 204 refers to a specific channel of the first feature data 202 and calculates coordinate values in the input image 200 with respect to a position higher in score than nearby positions. The first position estimation processing 204 returns the calculated coordinate values as the first processing result 206.

Second position estimation processing 205 refers to another channel of the first feature data 202 and performs processing similar to that performed by the first position estimation processing 204, thus returning the second processing result 207. The first position estimation processing 204 and the second position estimation processing 205 refer to the respective different channels according to the post-processing setting 203. For example, the first position estimation processing 204 refers to a channel corresponding to the head portion of a person. On the other hand, the second position estimation processing 205 refers to a channel corresponding to the body portion of a person.

Thus, the recognition processing illustrated in FIG. 2 implements a specific function by a combination of a CNN and post-processing operations. For example, the recognition processing calculates the positions of the head portion and body portion of a person shown in the input image 200, and outputs the calculated positions as the first processing result 206 and the second processing result 207.

In recognition processing including an NN, the sequence of a post-processing portion greatly varies depending on the purpose or target of the recognition processing. In the recognition processing illustrated in FIG. 2, the first CNN 201 is equivalent to a multiply-accumulate operation portion, and various processing operations located at stages later than the first CNN 201 are equivalent to a post-processing portion. For example, in a case where the position of only the head portion of a person only needs to be obtained, the second position estimation processing 205 is excluded from the recognition processing illustrated in FIG. 2 and the output also becomes only the first processing result 206. Alternatively, for example, in a case where not only the position of the head portion of a person but also the size thereof is wanted to obtain, the second position estimation processing 205 is replaced by another processing operation and the size of the head portion of a person becomes output from the second processing result 207.

FIG. 3 is a flowchart illustrating an example of conventional processing for performing different post-processing operations for the respective recognition processing operations. Upon starting post-processing, in step S301, the processing branches according to the type of the recognition processing. Here, it is assumed that, taking, as an example, the case of performing a post-processing portion of the recognition processing illustrated in FIG. 2, the processing advances to branch “0”. In step S302, the processing receives, as an input, input data required for post-processing from an external unit. Here, the processing receives, as an input, post-processing setting 203 required for performing the first position estimation processing 204 and the second position estimation processing 205.

In step S303, the processing performs position estimation processing. This is equivalent to the first position estimation processing 204 illustrated in FIG. 2. In step S304, the processing performs position estimation processing. This is equivalent to the second position estimation processing 205 illustrated in FIG. 2. In step S305, the processing outputs a result of post-processing to an external unit. Here, the processing outputs results of processing obtained in step S303 and step S304, i.e., the first processing result 206 and the second processing result 207 illustrated in FIG. 2.

In a case where the processing illustrated in the flowchart of FIG. 3 is implemented as software, as the number of types of the recognition processing increases, the total number of steps increases. For example, in the case of adding recognition processing which includes only one position estimation processing, step S307 to step S309 which lead from branch “1” are added. At this time, in a case where the respective steps are the same steps as those included in branch “0” but are different in the number of times of execution or the alignment sequence from those, the addition of respective steps at the branch destination becomes necessary.

Accordingly, in the above-mentioned conventional processing, as the number of types of the recognition processing increases, the program size of software with the sequence of a post-processing portion written therein also increases. Therefore, a data processing apparatus according to the first exemplary embodiment receives, as an input from an external unit, parameters representing a sequence of the entire recognition processing including a combination of a multiply-accumulate operation portion and a post-processing portion, thus preventing or reducing an increase in the program size due to the diversification of recognition processing operations.

### Configuration Example of Data Processing Apparatus

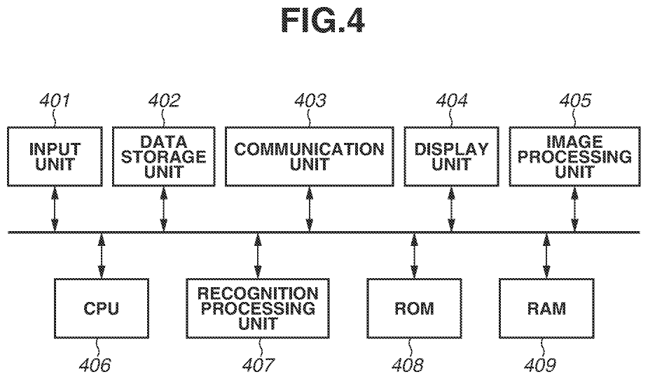

FIG. 4 is a block diagram illustrating an example of a configuration of the data processing apparatus, which is configured to perform a large variety of recognition processing operations while preventing or reducing an increase in the program size. An input unit 401 is a device which receives, as an input, an instruction or data from the user, and includes, for example, a keyboard, a pointing device, and buttons. Moreover, alternatively, a display unit 404 described below and the input unit 401 can be integrated as one device such as a known touch screen device. In that case, an input with use of a touch screen is treated as an input to the input unit 401.

A data storage unit 402 is a portion which stores image data. Usually, the data storage unit 402 is configured with, for example, a hard disk, a flexible disc, a compact disc-read-only memory (CD-ROM), a compact disc recordable (CD-R), a digital versatile disc (DVD), a memory card, a CompactFlash (CF) card, smart media, a Secure Digital (SD) card, a memory stick, an xD-Picture card, or a Universal Serial Bus (USB) memory. The data storage unit 402 is also able to store, in addition to image data, program and other types of data. Alternatively, a part of a random access memory (RAM) 409 can be used as the data storage unit 402. Moreover, alternatively, the data storage unit 402 can be configured virtually in such a way as to use a storage device included in an apparatus to which the data processing apparatus is connected via a communication unit 403 described below.

The communication unit 403 is an interface (I/F) which is used to perform communication between apparatuses. Furthermore, as illustrated in FIG. 4, all of the input unit 401, the data storage unit 402, and a display unit 404 described below are configured to be included in one apparatus. However, a configuration in which these units are interconnected via a communication path using a known communication method and are configured as mentioned above as a whole can be employed. The display unit 404 is a device which displays an image which is not yet subjected to image processing, an image which has been subjected to image processing, or an image for, for example, graphical user interface (GUI). Generally, for example, a cathode-ray tube (CRT) or a liquid crystal display is used as the display unit 404. Alternatively, the display unit 404 can be an external display device connected to the data processing apparatus via, for example, a cable.

An image processing unit 405 receives a command from a central processing unit (CPU) 406 described below, reads out image data written in the data storage unit 402, and performs range adjustment of pixel values. The image processing unit 405 writes a result of the processing into the RAM 409. The CPU 406 controls an operation of the entire data processing apparatus. A read-only memory (ROM) 408 and the RAM 409 provide, for example, a program, data, and a work area required for the CPU 406 to perform processing. In a case where a program required for processing described below is stored in the data storage unit 402 or the ROM 408, the program is once loaded onto the RAM 409 and is then executed by the CPU 406. Moreover, alternatively, in a case where the data processing apparatus receives the program via the communication unit 403, the program is once recorded on the data storage unit 402 and is then loaded onto the RAM 409. Moreover, the program can be directly loaded from the communication unit 403 onto the RAM 409 and is then executed by the CPU 406. Furthermore, while FIG. 4 illustrates a configuration in which only one CPU (CPU 406) is included, a configuration in which a plurality of CPUs is included can be employed.

A recognition processing unit 407 receives a command from the CPU 406 and performs recognition processing such as that illustrated in FIG. 2. The recognition processing unit 407 includes an internal storage required for execution of arithmetic operation processing. Data which the recognition processing unit 407 receives as an input can be data directly received from the communication unit 403 or can be data which is once loaded onto the RAM 409 and is then read into the recognition processing unit 407. Moreover, data which the recognition processing unit 407 returns as an output can be directly sent to the communication unit 403 or can be written into the RAM 409.

The system configuration of the data processing apparatus includes various constituent components in addition to the above-mentioned units but is not the gist of the present disclosure and is, therefore, omitted from description.

### Configuration Example of Recognition Processing Unit

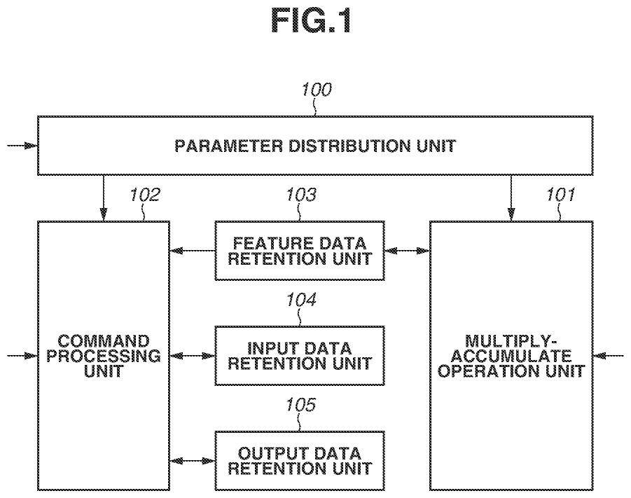

FIG. 1 illustrates a configuration of the recognition processing unit 407. The recognition processing unit 407 includes three arithmetic operation units, i.e., a parameter distribution unit 100, a multiply-accumulate operation unit 101, and a command processing unit 102, and three storage units, i.e., a feature data retention unit 103, an input data retention unit 104, and an output data retention unit 105.

The parameter distribution unit 100 receives parameters from an external unit and distributes the parameters to the multiply-accumulate operation unit 101 or the command processing unit 102 according to contents of the parameters. Upon the completion of processing operations corresponding to the respective received parameters, each of the multiply-accumulate operation unit 101 and the command processing unit 102 sends an ending notification to the parameter distribution unit 100. Upon receiving the ending notification, the parameter distribution unit 100 starts distributing next parameters.

A parameter which the parameter distribution unit 100 gives to the multiply-accumulate operation unit 101 is referred to as a “multiply-accumulate operation parameter”. The multiply-accumulate operation parameter includes information required for the multiply-accumulate operation unit 101 to execute a multiply-accumulate operation portion of recognition processing. For example, information about parameters such as weight coefficients of an NN or the number of channels of feature data to be calculated is included in the multiply-accumulate operation parameter.

A parameter which the parameter distribution unit 100 gives to the command processing unit 102 is referred to as a “post-processing parameter”. The post-processing parameter is, in other words, a command sequence. A series of processing operations which the command processing unit 102 performs, in other words, a post-processing portion of recognition processing, is implemented by a combination of preliminarily defined processing operations. The parameter distribution unit 100 gives one command to the command processing unit 102, thus causing the command processing unit 102 to perform any one of the preliminarily defined processing operations.

The parameter distribution unit 100 plays the role of administering a sequence for a series of recognition processing operations which the recognition processing unit 407 performs. The parameter distribution unit 100 causes the multiply-accumulate operation unit 101 and the command processing unit 102 to operate in an appropriate sequential order according to a sequence for recognition processing. On the other hand, the sequential order is determined by the alignment sequence of a multiply-accumulate operation parameter and a post-processing parameter included in the parameters. Accordingly, giving a processing order associated with a sequence for recognition processing is the role of a side which gives parameters as an external input to the parameter distribution unit 100.

Similarly, the parameter distribution unit 100 plays the role of administering a sequence for a post-processing portion of recognition processing which the command processing unit 102 performs, and the sequential order thereof is determined by the alignment sequence of commands included in the post-processing parameter. Accordingly, giving a processing order associated with a sequence for a post-processing portion is the role of a side which gives parameters as an external input to the parameter distribution unit 100.

The multiply-accumulate operation unit 101 performs processing for a multiply-accumulate operation portion of recognition processing according to the multiply-accumulate operation parameter received from the parameter distribution unit 100. In the processing for a multiply-accumulate operation portion, the multiply-accumulate operation unit 101 receives an input image from an external unit, calculates feature data from the input image, and writes the calculated feature data into the feature data retention unit 103. In the first exemplary embodiment, the multiply-accumulate operation unit 101 is assumed to be configured with dedicated hardware including a great number of multipliers and a great number of adders and be able to process a multiply-accumulate operation portion of recognition processing more efficiently than, for example, when the CPU 406 performs multiply-accumulate operation. The feature data retention unit 103 is a multiply-accumulate operation result retention unit which retains, as feature data, a multiply-accumulate operation result in the multiply-accumulate operation portion.

Furthermore, the arithmetic operation processing which the multiply-accumulate operation unit 101 performs is not necessarily limited to multiply-accumulate operation as long as it has a feature close to multiply-accumulate operation such as playing the role of feature extraction in NN arithmetic operation or facilitating parallelization using dedicated hardware. For example, in an NN using feature data of one bit taking binary of ±1 and weight coefficients, the multiply-accumulate operation unit 101 performs XNOR arithmetic operation and popcount processing instead of multiplication and addition. Moreover, the arithmetic operation processing which the multiply-accumulate operation unit 101 performs can include, in front of or behind multiply-accumulate operation, processing other than multiply-accumulate operation, such as processing of an activating function or pooling processing.

The command processing unit 102 performs processing for a post-processing portion of recognition processing according to a post-processing parameter received from the parameter distribution unit 100. In the post-processing portion, the command processing unit 102 reads out feature data calculated by the multiply-accumulate operation unit 101 from the feature data retention unit 103 and performs processing on the feature data according to post-processing setting placed in the input data retention unit 104. The command processing unit 102 writes a result of the processing into the output data retention unit 105. Moreover, the command processing unit 102 also performs processing operations such as processing for receiving post-processing setting from an external unit and then storing the post-processing setting in the input data retention unit 104 and processing for passing a processing result written into the output data retention unit 105 to an external unit.

The post-processing parameter, which the parameter distribution unit 100 gives to the command processing unit 102, is configured as a sequence of small parameters indicating preliminarily defined processing. Each of small parameters constituting the sequence is hereinafter referred to as a “command”. The command processing unit 102 performs processing corresponding to the type of command for each command. The command processing unit 102 performs the above-mentioned processing in the course of a series of sequences given with a sequence of commands.

Furthermore, each of units included in the recognition processing unit 407 as separate constituent elements can be implemented with a single device. For example, each of the parameter distribution unit 100 and the command processing unit 102 can be implemented as the CPU 406 and a program loaded thereon. In that case, the CPU 406, serving as the parameter distribution unit 100, receives a parameter and, if the received parameter is a parameter directed to the multiply-accumulate operation unit 101, transfer the received parameter to the multiply-accumulate operation unit 101. On the other hand, if the received parameter is a parameter directed to the command processing unit 102, the CPU 406 directly performs processing equivalent to the command processing unit 102.

FIG. 5 is a flowchart illustrating processing which the command processing unit 102 performs. Upon starting the processing, in step S501, the command processing unit 102 receives commands one by one from the parameter distribution unit 100 and starts a loop of commands each time receiving a command.

In step S502, the command processing unit 102 causes the processing to branch depending on the value of a TYPE field of the command. TYPE is a value indicating the type of the command, i.e., which of preliminarily defined processing operations the command is. If it is determined that TYPE is “0” (0 in step S502), the command processing unit 102 causes the processing to branch to step S503 for “input processing”. If it is determined that TYPE is “1” (1 in step S502), the command processing unit 102 causes the processing to branch to step S505 for “execution”. If it is determined that TYPE is “2” (2 in step S502), the command processing unit 102 causes the processing to branch to step S504 for “output processing”.

In step S503, the command processing unit 102 performs a processing operation equivalent to step S302 illustrated in FIG. 3. Thus, the command processing unit 102 receives input data for post-processing from an external unit and then stores the input data in the input data retention unit 104. In step S504, the command processing unit 102 performs a processing operation equivalent to step S305 illustrated in FIG. 3. Thus, the command processing unit 102 outputs an output result of the post-processing stored in the output data retention unit 105 to an external unit.

In step S505, the command processing unit 102 performs processing operations equivalent to step S303 and step S304 illustrated in FIG. 3, thus selecting any one of preliminarily defined post-processing operations. The command with TYPE of “1” has a SUB_TYPE field, so that, in step S505, the command processing unit 102 causes the processing to branch depending on the value of the SUB_TYPE field. For example, in the case of selecting position estimation processing, which is performed in step S303 and step S304, the command processing unit 102 sets “0” to the SUB_TYPE field. In the case of performing other processing operations, the command processing unit 102 sets a value other than “0” to the SUB_TYPE field, but which is not dealt with in the description of the first exemplary embodiment.

In step S506, the command processing unit 102 performs position estimation processing. Specifically, the command processing unit 102 refers to feature data stored in the feature data retention unit 103 and, according to post-processing setting stored in the input data retention unit 104, calculates the coordinates of a position which is high in score with respect to a specific channel. The command processing unit 102 stores the obtained result as a processing result in the output data retention unit 105.

In step S507, the command processing unit 102 sends an ending instruction to the parameter distribution unit 100, thus ending the current loop of commands and waiting for next commands.

### Program Size

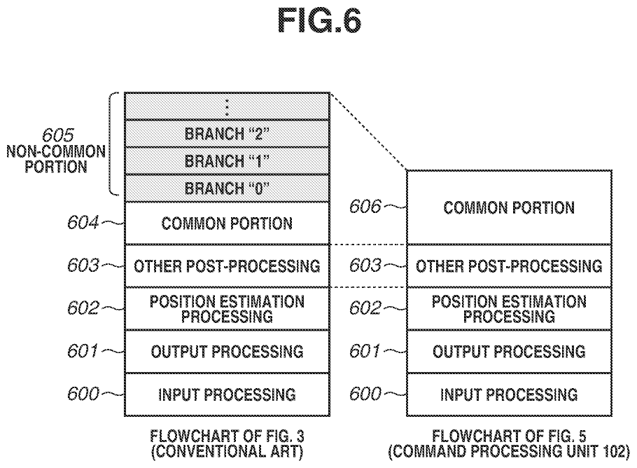

FIG. 6 illustrates relationships between the flowcharts illustrated in FIG. 3 and FIG. 5 and between the program sizes thereof.

Specifically, FIG. 6 illustrates differences of program sizes in a case where the flowchart of FIG. 3 on the left side portion and the flowchart of FIG. 5 on the right side portion are implemented as software, as heights obtained by stacking program sizes of the respective processing operations.

A program size of input processing 600, a program size of output processing 601, and a program size of position estimation processing 602 are included in each of the cases of the flowchart of FIG. 3 and the flowchart of FIG. 5. In FIG. 3 and FIG. 5, no difference in program size occurs between these processing operations.

A program size of other post-processing 603 is an addition of program size obtained in the case of adding a type of post-processing besides position estimation processing, such as association processing in step S313 illustrated in FIG. 3. In FIG. 3 and FIG. 5, in a case where it is assumed that the types of recognition processing operations to be supported are exactly the same, the types of post-processing operations to be added are also exactly the same, so that no difference in program size occurs between these processing operations.

A program size of common portion 604 in the flowchart of FIG. 3 is an addition of program size caused by a processing operation which does not depend on the type of recognition processing, such as that in step S301.

A program size of non-common portion 605 in the flowchart of FIG. 3 is an addition of program size caused by a portion in which sequences for the respective types of recognition processing are written. The program size of non-common portion 605 increases as the number of branches subsequent to step S301 increases due to an increase in the number of types of recognition processing.

On the other hand, a program size of common portion 606 in the flowchart of FIG. 5 is an addition of program size caused by a portion in which sequences, such as repetition and branching, other than the respective processing operations such as those in step S503 to step S506 are written. Even if the number of types of recognition processing increases, the program size of common portion 606 does not increase unless the number of types of command processing constituting the recognition processing increases.

As described above, assuming that the types of recognition processing to be supported in FIG. 3 and FIG. 5 are the same, the accumulated value of program sizes in the flowchart of FIG. 3 becomes larger as the number of types of recognition processing is larger. On the other hand, the accumulated value of program sizes in the flowchart of FIG. 5 is constant regardless of the number of types of recognition processing. Giving sequences which differ by types of recognition processing as parameters from an external unit enables the data processing apparatus in the first exemplary embodiment to support various recognition processing operations while preventing or reducing an increase in the program size.

### Parameters and Sequences

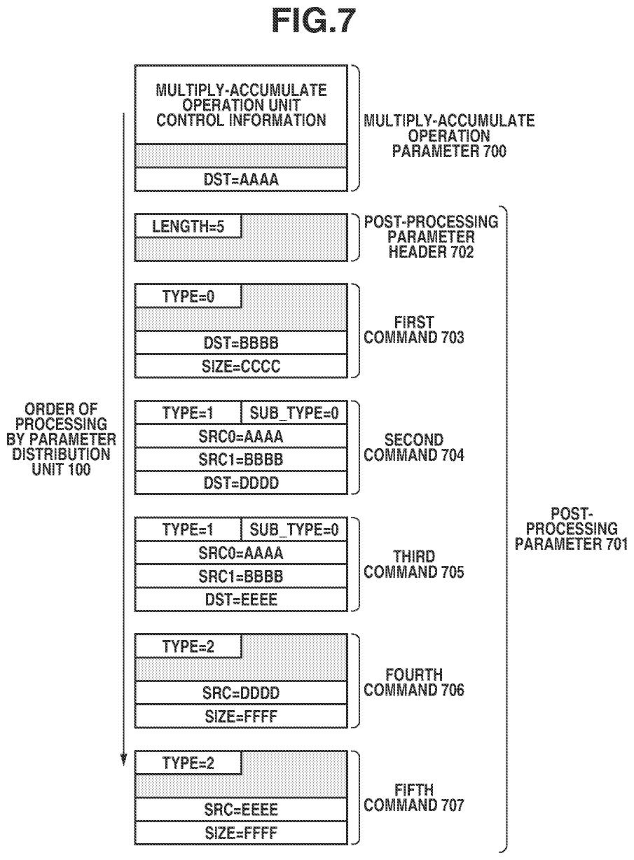

In the following description, what parameters to actually give so as to implement the recognition processing illustrated in FIG. 2 is illustrated by an example. FIG. 7 illustrates examples of configurations of parameters which are given to the recognition processing unit 407 so as to implement the recognition processing illustrated in FIG. 2. The parameters include a multiply-accumulate operation parameter 700 and a post-processing parameter 701, which are interconnected in this order. Accordingly, the recognition processing unit 407 causes the multiply-accumulate operation unit 101 to process the multiply-accumulate operation portion and then causes the command processing unit 102 to process the post-processing portion.

The multiply-accumulate operation parameter 700 is used to execute the first CNN 201. The multiply-accumulate operation parameter 700 includes control information required for processing for the multiply-accumulate operation unit 101. Moreover, the multiply-accumulate operation parameter 700 further includes a DST field, which designates in what address of the feature data retention unit 103 to store the first feature data 202. The details of the control information are irrelevant to the gist of the present disclosure and are, therefore, omitted from description.

The post-processing parameter 701 includes a post-processing parameter header 702 and commands 703 to 707. The LENGTH field of the post-processing parameter header 702 is given the number of commands. The parameter distribution unit 100 refers to the LENGTH field and thus sends commands the number of which is required to the command processing unit 102.

The first command 703 has a TYPE field set to “0” and is thus used to perform input processing. The input processing is processing for receiving the post-processing setting 203 from an external unit and stores the received post-processing setting 203 in the input data retention unit 104. The first command 703 has a DST field which is set to indicate in what address of the input data retention unit 104 to store the post-processing setting 203. The first command 703 has a SIZE field which is given the data size of data received from an external unit, i.e., the data size of the post-processing setting 203.

The second command 704 has a TYPE field set to “1” and a SUB_TYPE field set to “0” and is used to perform the first position estimation processing 204. The second command 704 has an SRC0 field, which is used to give a storage location of the first feature data 202, set to the same address as that designated in the DST field of the multiply-accumulate operation parameter 700, and also has an SRC1 field, which is used to give a storage location of the post-processing setting 203, set to the same address as that designated in the DST field of the first command 703. The second command 704 has a DST field which is set to indicate in what address of the output data retention unit 105 to store the first processing result 206.

The third command 705 has a TYPE field set to “1” and a SUB_TYPE field set to “1” and is used to perform the second position estimation processing 205. The third command 705 has an SRC0 field, which is used to give a storage location of the first feature data 202, set to the same address as that designated in the DST field of the multiply-accumulate operation parameter 700, and also has an SRC1 field, which is used to give a storage location of the post-processing setting 203, set to the same address as that designated in the DST field of the first command 703. The third command 705 has a DST field which is set to indicate in what address of the output data retention unit 105 to store the second processing result 207.

The fourth command 706 has a TYPE field set to “2” and is used to perform output processing. The output processing is processing for outputting the first processing result 206 stored in the output data retention unit 105 to an external unit.

The fourth command 706 has an SRC field, which is used to give a storage location of the first processing result 206 serving as a target for outputting, set to the same address as that designated in the DST field of the second command 704.

The fifth command 707 has a TYPE field set to “2” and is used to perform output processing. The output processing is processing for outputting the second processing result 207 stored in the output data retention unit 105 to an external unit.

The fifth command 707 has an SRC field, which is used to give a storage location of the second processing result 207 serving as a target for outputting, set to the same address as that designated in the DST field of the third command 705.

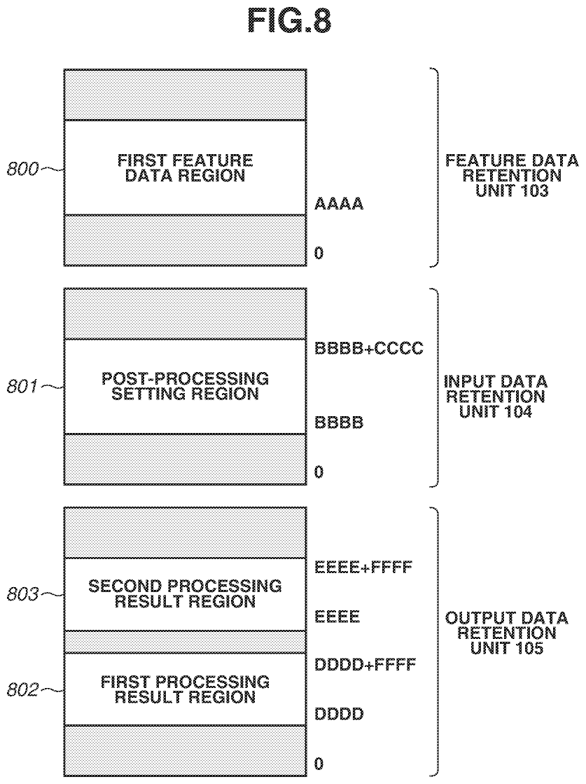

FIG. 8 illustrates a memory map which is used for the recognition processing unit 407 to perform processing with use of the parameters illustrated in FIG. 7. Furthermore, while, in FIG. 8, the feature data retention unit 103, the input data retention unit 104, and the output data retention unit 105 are configured as respective separate memories, one memory such as the RAM 409 can be used as all of such three retention units.

The feature data retention unit 103 is provided with a first feature data region 800, which is used to store the first feature data 202. According to the DST field of the multiply-accumulate operation parameter 700, the start address of the first feature data region 800 becomes “AAAA”. In the second command 704 and the third command 705, which access the first feature data region 800, “AAAA” is set to the corresponding field, i.e., the SRC0 field.

The input data retention unit 104 is provided with a post-processing setting region 801, which is used to store the post-processing setting 203. According to the DST field of the first command 703, the start address of the post-processing setting region 801 becomes “BBBB”. In the second command 704 and the third command 705, which access the post-processing setting region 801, “BBBB” is set to the corresponding field, i.e., the SRC1 field.

The output data retention unit 105 is provided with a first processing result region 802 and a second processing result region 803, which are used to store the first processing result 206 and the second processing result 207, respectively. According to the DST field of the second command 704, the start address of the first processing result region 802 becomes “DDDD”. According to the DST field of the third command 705, the start address of the second processing result region 803 becomes “EEEE”. In the fourth command 706 and the fifth command 707, which access the first processing result region 802 and the second processing result region 803, “DDDD” and “EEEE” are set to the corresponding field, i.e., the SRC field, respectively.

Furthermore, for example, the first processing result region 802 and the second processing result region 803 can be arranged while being interconnected and the first processing result 206 and the second processing result 207 can be output to an external unit with one output processing operation being performed. In that case, the fourth command 706 and the fifth command 707 can be aggregated into one command and the address of the top position of the first processing result region 802 can be set to the SRC field. Moreover, “2×FFFF”, which is the sum of sizes of the first processing result region 802 and the second processing result region 803, can be given to the SIZE field.

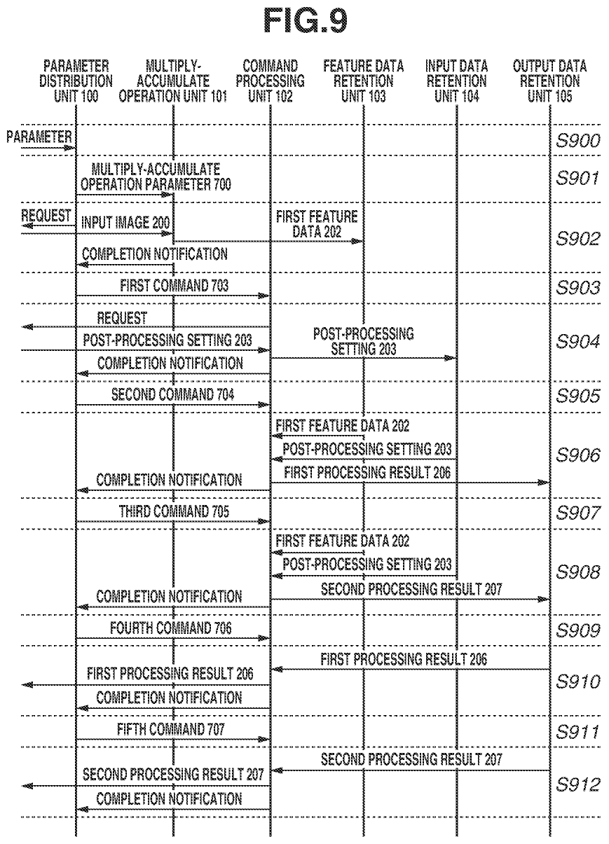

FIG. 9 illustrates a sequence which the recognition processing unit 407 performs for processing with use of the parameters illustrated in FIG. 7. In step S900, the parameter distribution unit 100 receives parameters from an external unit, and starts a series of recognition processing operations illustrated in FIG. 2. In step S901, the parameter distribution unit 100 transmits the multiply-accumulate operation parameter 700 to the multiply-accumulate operation unit 101.

In step S902, the multiply-accumulate operation unit 101 starts processing of the first CNN 201 according to the received multiply-accumulate operation parameter 700. Specifically, first, the multiply-accumulate operation unit 101 receives the input image 200 from an external unit. Next, the multiply-accumulate operation unit 101 calculates the first feature data 202 and stores the calculated first feature data 202 in the feature data retention unit 103. Lastly, the multiply-accumulate operation unit 101 transmits a processing completion notification to the parameter distribution unit 100. In step S903, the parameter distribution unit 100 starts transfer of the post-processing parameter 701. Specifically, the parameter distribution unit 100 transmits commands at five different times to the command processing unit 102 according to the setting of the LENGTH field of the post-processing parameter header 702. First, the parameter distribution unit 100 transmits the first command 703.

In step S904, the command processing unit 102 starts the input processing according to the first command 703. Specifically, first, the command processing unit 102 receives the post-processing setting 203 from an external unit. Next, the command processing unit 102 stores the received post-processing setting 203 in the input data retention unit 104. Lastly, the command processing unit 102 transmits a processing completion notification to the parameter distribution unit 100.

In step S905, the parameter distribution unit 100 transmits the second command 704 to the command processing unit 102. In step S906, the command processing unit 102 starts the first position estimation processing 204 according to the second command 704. Specifically, first, the command processing unit 102 reads out the first feature data 202 from the feature data retention unit 103 and reads out the post-processing setting 203 from the input data retention unit 104.

Next, the command processing unit 102 refers to a specific channel of the first feature data 202, obtains the coordinates of a position the score of which is high, and stores the obtained coordinates as the first processing result 206 in the output data retention unit 105. Lastly, the command processing unit 102 transmits a processing completion notification to the parameter distribution unit 100.

In step S907, the parameter distribution unit 100 transmits the third command 705 to the command processing unit 102. In step S908, the command processing unit 102 starts the second position estimation processing 205 according to the third command 705. Specifically, first, the command processing unit 102 receives the first feature data 202 from the feature data retention unit 103 and receives the post-processing setting 203 from the input data retention unit 104.

Next, the command processing unit 102 refers to a specific channel of the first feature data 202, obtains the coordinates of a position the score of which is higher than those of nearby positions, and stores the obtained coordinates as the second processing result 207 in the output data retention unit 105. Lastly, the command processing unit 102 transmits a processing completion notification to the parameter distribution unit 100.

In step S909, the parameter distribution unit 100 transmits the fourth command 706 to the command processing unit 102. In step S910, the command processing unit 102 starts the output processing according to the fourth command 706. Specifically, first, the command processing unit 102 reads out the first processing result 206 from the output data retention unit 105. Next, the command processing unit 102 outputs the read-out first processing result 206 to an external unit. Lastly, the command processing unit 102 transmits a processing completion notification to the parameter distribution unit 100.

In step S911, the parameter distribution unit 100 transmits the fifth command 707 to the command processing unit 102. In step S912, the command processing unit 102 starts the output processing according to the fifth command 707. Specifically, first, the command processing unit 102 reads out the second processing result 207 from the output data retention unit 105. Next, the command processing unit 102 outputs the read-out second processing result 207 to an external unit. Lastly, the command processing unit 102 transmits a processing completion notification to the parameter distribution unit 100.

As described above, giving the parameters illustrated in FIG. 7 enables the recognition processing unit 407 to perform a series of recognition processing operations illustrated in FIG. 2 from when receiving the input image 200 and the post-processing setting 203 until returning the first processing result 206 and the second processing result 207. Moreover, in the case of performing recognition processing operations different from those illustrated in FIG. 2, the sequence can be defined by parameters different from those illustrated in FIG. 7. This enables the recognition processing unit 407 to deal with a greater number of types of recognition processing without increasing the program size.

In the first exemplary embodiment, a configuration in which the variation of a sequence of the post-processing portion of recognition processing does not influence the program size of the command processing unit 102 and, overall, an increase in the program size of the recognition processing unit 407 is prevented or reduced has been described. This is implemented by a configuration in which post-processing sequences different for respective recognition processing operations are given as a command sequence from an external unit and the parameter distribution unit 100 instructs the command processing unit 102 to perform processing operations in a sequential order corresponding to the alignment sequence of commands included in the post-processing parameter.

The second exemplary embodiment is configured to give a sequence for recognition processing in an alignment sequence including not only a parameter for controlling the post-processing portion of recognition processing, i.e., a command sequence, but also a parameter for the multiply-accumulate operation portion of recognition processing. Giving parameters with an appropriate configuration implements recognition processing which is not definable only by permutation of commands as in the first exemplary embodiment. Moreover, the second exemplary embodiment illustrates examples of the extension of commands and how to give a sequence for more efficiently performing recognition processing.

Furthermore, in the following description, portions different from those in the first exemplary embodiment and new portions added in the second exemplary embodiment are mainly described, and the other portions are omitted from description. The configurations and features included in the data processing apparatus described in the first exemplary embodiment are also applicable to the second exemplary embodiment unless otherwise described.

### Post-Processing and Diversification in Sequence

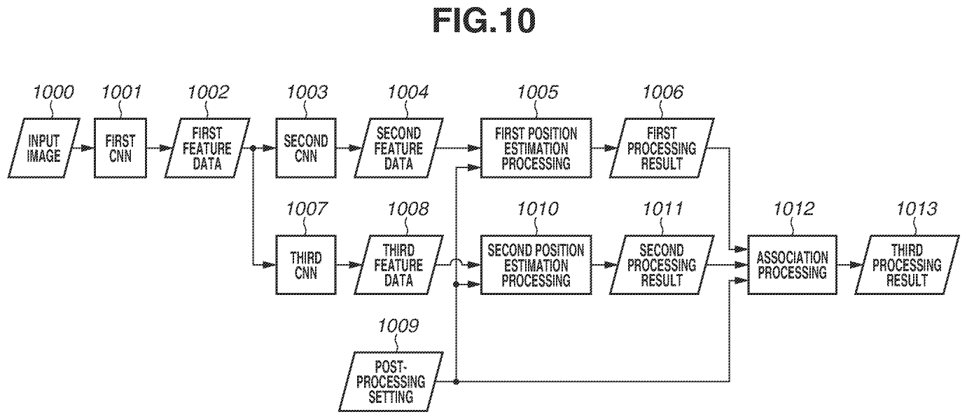

FIG. 10 illustrates a configuration of recognition processing targeted for execution in the second exemplary embodiment. The recognition processing illustrated in FIG. 10 is configured with three CNNs and three post-processing operations which use the outputs of the CNNs. This recognition processing is configured to receive an input image 1000 and post-processing setting 1009 and then return a first processing result 1006, a second processing result 1011, and a third processing result 1013.

The first CNN 1001 receives the input image 1000 and performs multiply-accumulate operation on the input image 1000. The first CNN 1001 returns first feature data 1002 as a result of multiply-accumulate operation. The first feature data 1002 is a plurality of score maps representing the scores of positions corresponding to the input image 1000. Hereinafter, each of the score maps is referred to as a “channel”.

The second CNN 1003 receives the first feature data 1002 and performs further multiply-accumulate operation on the first feature data 1002. The second CNN 1003 returns second feature data 1004 as a result of multiply-accumulate operation. The third CNN 1007, as with the second CNN 1003, receives the first feature data 1002 and performs further multiply-accumulate operation on the first feature data 1002. The third CNN 1007 returns third feature data 1008 as a result of multiply-accumulate operation.

Each of the second CNN 1003 and the third CNN 1007 is preliminarily trained in such a way as to output a high score with respect to a region in which a specific subject is shown in the input image 1000. For example, in the second feature data 1004 which the second CNN 1003 outputs, the score becomes high with respect to a region in which the head portion of a person is shown. Moreover, in the third feature data 1008 which the third CNN 1007 outputs, the score becomes high with respect to a region in which the body portion of a person is shown. Accordingly, in the second exemplary embodiment, the function which the first CNN 201 implements in the first exemplary embodiment is implemented by a CNN group in which three CNNs, i.e., the first CNN 1001, the second CNN 1003, and the third CNN 1007, are interconnected.

First position estimation processing 1005 refers to the second feature data 1004, calculates coordinate values in the input image 1000 with respect to a position higher in score than nearby positions, and returns the calculated coordinate values as the first processing result 1006. Furthermore, the first position estimation processing 1005 can calculate coordinate values with respect to each of a plurality of subjects, and the first processing result 1006 can include a plurality of sets of coordinate values as a list.

Second position estimation processing 1010 refers to the third feature data 1008, calculates coordinate values in the input image 1000 with respect to a position higher in score than nearby positions, and returns the calculated coordinate values as the second processing result 1011. As with the first processing result 1006, the second processing result 1011 can also include coordinate values with respect to a plurality of subjects as a list.

Thus, in the second exemplary embodiment, the function equivalent to the recognition processing illustrated in FIG. 2 is implemented by a series of processing operations starting with the first CNN 1001 and ending with the second position estimation processing 1010. In addition to this, in the second exemplary embodiment, association processing 1012 is performed.

The association processing 1012 receives the first processing result 1006 and the second processing result 1011, and performs association between subjects the position coordinates of each of which have been calculated. For example, with use of information about, for example, a distance or positional relationship between subjects, the association processing 1012 associates the head portion and the body portion which are estimated to be included in the same person with each other.

The association processing 1012 gives a result of association as a pair including an index of the head portion and an index of the body portion, and returns such a pair as the third processing result 1013.

Thus, the recognition processing illustrated in FIG. 10 implements a specific function by a combination of CNNs and post-processing operations. For example, the recognition processing calculates the positions of the respective head portions of a plurality of persons shown in the input image 1000, and outputs the calculated positions as the first processing result 1006. Moreover, the recognition processing calculates the positions of the respective body portions of a plurality of persons shown in the input image 1000, and outputs the calculated positions as the second processing result 1011. Additionally, if there is a person both the head portion and body portion of whom are shown in the input image 1000, the recognition processing outputs, as the third processing result 1013, information indicating what number-th person in each of the first processing result 1006 and the second processing result 1011 the shown person is.

In the recognition processing illustrated in FIG. 10, the first CNN 1001, the second CNN 1003, and the third CNN 1007 are equivalent to a multiply-accumulate operation portion. The first position estimation processing 1005, the second position estimation processing 1010, and the association processing 1012 are equivalent to a post-processing portion. To execute only the post-processing portion of the recognition processing illustrated in FIG. 10, for example, a procedure indicated by branch “2” in the flowchart illustrated in FIG. 3 is followed.

In step S310, the processing receives, as an input, input data required for post-processing from an external unit. Here, the processing receives, as an input, the post-processing setting 1009 required for performing the first position estimation processing 1005, the second position estimation processing 1010, and the association processing 1012. In step S311, the processing performs position estimation processing. This is equivalent to the first position estimation processing 1005 illustrated in FIG. 10. In step S312, the processing performs position estimation processing. This is equivalent to the second position estimation processing 1010 illustrated in FIG. 10.

In step S313, the processing performs association processing. This is equivalent to the association processing 1012 illustrated in FIG. 10. In step S314, the processing outputs a result of post-processing to an external unit. Here, the processing outputs results of processing obtained in step S311 to step S313, i.e., the first processing result 1006, the second processing result 1011, and the third processing result 1013 illustrated in FIG. 10.

As a feature of the recognition processing illustrated in FIG. 10, branching exists in a dependency relationship of data. Specifically, with the first feature data 1002 set as a branch point, the processing branches into processing leading from the second CNN 1003 and processing leading from the third CNN 1007. These merge again at the association processing 1012.

In the second exemplary embodiment, in recognition processing having branching, speeding up using parallel processing is attempted by defining an appropriate sequence using parameters. In the following description, the extension of the command processing unit 102 required for such speeding up and how to give parameters to perform the recognition processing illustrated in FIG. 10 at higher speed are described.

### Configuration Example of Data Processing Apparatus According to Second Exemplary Embodiment

In the second exemplary embodiment, as with the first exemplary embodiment, the data processing apparatus and the recognition processing unit 407 having the respective configurations illustrated in FIG. 4 and FIG. 1 are used. In the following description, portions different from those in the first exemplary embodiment and new portions added in the second exemplary embodiment are described.

FIG. 11 is a flowchart of processing which the command processing unit 102 performs in the second exemplary embodiment. Step S1101 to step S1106 are processing operations equivalent to those in step S501 to step S506 in the first exemplary embodiment. In step S1107, the command processing unit 102 performs association processing. Specifically, the command processing unit 102 refers to two results of position estimation processing stored in the output data retention unit 105, and performs association between subjects included in the two results of position estimation processing according to the post-processing setting stored in the input data retention unit 104. The command processing unit 102 stores the result of association as a processing result in the output data retention unit 105.

In the second exemplary embodiment, the recognition processing unit 407 performs communication with an external arithmetic operation device such as the CPU 406. To implement this, processing for the command processing unit 102 to perform communication with an external arithmetic operation device is defined. To perform these, “3” is set to the TYPE field of a command.

In step S1108, the command processing unit 102 selects the type of communication with an external arithmetic operation device with respect to the command to the TYPE field of which “3” has been set. The command with “3” set to the TYPE field thereof has a SUB_TYPE field. In a case where the value of the SUB_TYPE field is “0” (0 in step S1108), the command processing unit 102 advances the processing to step S1109 to issue an instruction for starting arithmetic operation processing. In a case where the value of the SUB_TYPE field is “1” (1 in step S1108), the command processing unit 102 advances the processing to step S1110 to wait for ending of arithmetic operation processing.

In step S1109, the command processing unit 102 transmits a message indicating an instruction for starting arithmetic operation processing to an external arithmetic operation device. The content of the message to be transmitted is designated with an MSG field included in the command. In step S1110, the command processing unit 102 transmits a message indicating waiting for ending of arithmetic operation processing to an external arithmetic operation device. After transmitting the message, the command processing unit 102 waits until receiving a notification of ending of the processing designated with the MSG field by the external arithmetic operation device.

In the following description, for sake of simplicity, it is assumed that the external arithmetic operation device refers to the CPU 406. The CPU 406 receives a message indicating an instruction for starting from the command processing unit 102, and starts the designated processing. Moreover, the CPU 406 receives a message indicating waiting for ending from the command processing unit 102, and, if the designated processing is completed, returns an ending notification on the moment. If the designated processing is not yet completed, the CPU 406 continues the processing and, after completion of the processing, returns an ending notification.

Thus, the command processing unit 102 in the second exemplary embodiment supports a command required for communication with an external arithmetic operation device in addition to three types of commands supported in the first exemplary embodiment. Furthermore, the recognition processing unit 407 including the command processing unit 102 implemented by the flowchart illustrated in FIG. 11 is given the parameters illustrated in FIG. 7 and is thus able to perform the recognition processing illustrated in FIG. 2, as with the first exemplary embodiment. Similarly, the other recognition processing operations which are able to be performed in the first exemplary embodiment are also able to be performed in the second exemplary embodiment with the same respective parameters as those in the first exemplary embodiment being given.

### Parameters and Sequences

In the following description, what parameters to actually give so as to implement the recognition processing illustrated in FIG. 10 is illustrated by an example. In the second exemplary embodiment, the recognition processing unit 407 and the CPU 406 perform parallel processing to attempt speeding up of the recognition processing illustrated in FIG. 10. In the parameters which are given to the recognition processing unit 407, a sequence required for association between the recognition processing unit 407 and the CPU 406 is defined.

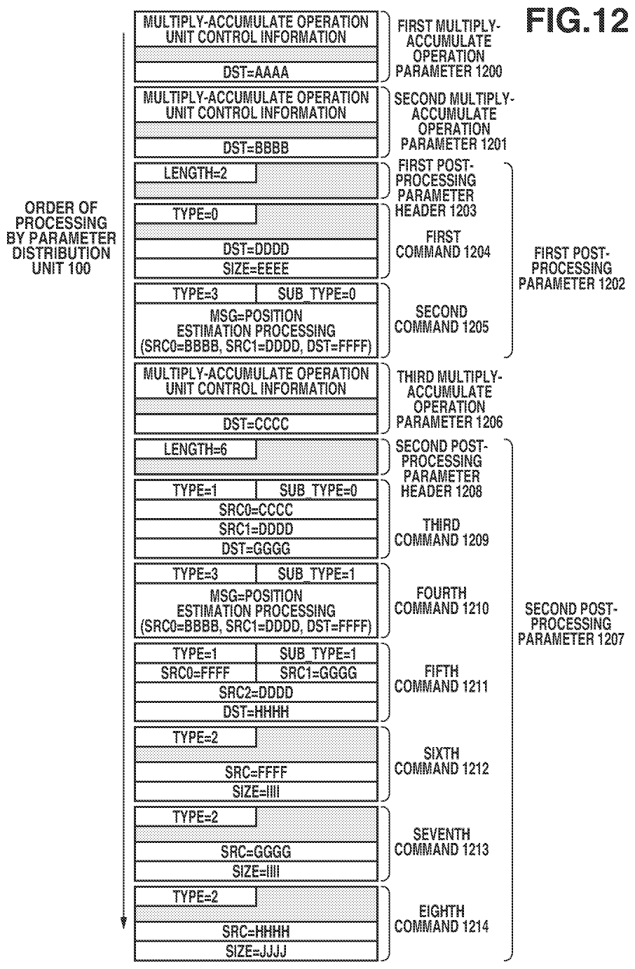

FIG. 12 illustrates examples of configurations of parameters which are given to the recognition processing unit 407 so as to implement the recognition processing illustrated in FIG. 10. The parameters include a first multiply-accumulate operation parameter 1200, a second multiply-accumulate operation parameter 1201, a first post-processing parameter 1202, a third multiply-accumulate operation parameter 1206, and a second post-processing parameter 1207, which are interconnected in this order. Accordingly, the second exemplary embodiment is configured to, without collectively executing post-processing portions as in the flowchart illustrated in FIG. 3, alternately execute a multiply-accumulate operation portion and a post-processing portion.

The first multiply-accumulate operation parameter 1200 is used to execute the first CNN 1001. The first multiply-accumulate operation parameter 1200 includes control information required for processing for the multiply-accumulate operation unit. Moreover, the first multiply-accumulate operation parameter 1200 further includes a DST field, which designates in what address of the feature data retention unit 103 to store the first feature data 1002. The second multiply-accumulate operation parameter 1201 is used to execute the second CNN 1003. The second multiply-accumulate operation parameter 1201 includes control information required for processing for the multiply-accumulate operation unit. Moreover, the second multiply-accumulate operation parameter 1201 further includes a DST field, which designates in what address of the feature data retention unit 103 to store the second feature data 1004.

The first post-processing parameter 1202 includes a first post-processing parameter header 1203 and commands 1204 and 1205. The LENGTH field of the first post-processing parameter header 1203 is given the number of commands. The parameter distribution unit 100 refers to the LENGTH field and thus sends commands the number of which is desired to the command processing unit 102.

The first command 1204 has a TYPE field set to “0” and is thus used to perform input processing. The input processing is processing for receiving the post-processing setting 1009 from an external unit and stores the received post-processing setting 1009 in the input data retention unit 104. The first command 1204 has a DST field which is set to indicate in what address of the input data retention unit 104 to store the post-processing setting 1009. The first command 1204 has a SIZE field which is given the data size of data received from an external unit, i.e., the data size of the post-processing setting 1009.

The second command 1205 has a TYPE field set to “3” and a SUB_TYPE field set to “0” and is used to perform start instruction processing. Specifically, the command processing unit 102 transmits a message to the CPU 406. The CPU 406 starts the first position estimation processing 1005 according to the content of the message. The MSG field is given the contents of the SRC0, SRC1, and DST fields required for the first position estimation processing 1005. The second command 1205 has the SRC0 field, which is used to give a storage location of the second feature data 1004, set to the same address as that designated in the DST field of the second multiply-accumulate operation parameter 1201, and also has the SRC1 field, which is used to give a storage location of the post-processing setting 1009, set to the same address as that designated in the DST field of the first command 1204. The second command 1205 has the DST field, which is set to indicate in what address of the output data retention unit 105 to store the first processing result 1006.

The third multiply-accumulate operation parameter 1206 is used to execute the third CNN 1007. The third multiply-accumulate operation parameter 1206 includes control information required for processing for the multiply-accumulate operation unit. Moreover, the third multiply-accumulate operation parameter 1206 further includes a DST field, which designates in what address of the feature data retention unit 103 to store the third feature data 1008.

The second post-processing parameter 1207 includes a second post-processing parameter header 1208 and commands 1209 to 1214. The LENGTH field of the second post-processing parameter header 1208 is given the number of commands. The parameter distribution unit 100 refers to the LENGTH field and thus sends commands the number of which is required to the command processing unit 102.

The third command 1209 has a TYPE field set to “1” and a SUB_TYPE field set to “0” and is used to perform the second position estimation processing 1010. The third command 1209 has an SRC0 field, which is used to give a storage location of the third feature data 1008, set to the same address as that designated in the DST field of the third multiply-accumulate operation parameter 1206, and also has an SRC1 field, which is used to give a storage location of the post-processing setting 1009, set to the same address as that designated in the DST field of the first command 1204. The third command 1209 has a DST field which is set to indicate in what address of the output data retention unit 105 to store the second processing result 1011.

The fourth command 1210 has a TYPE field set to “3” and a SUB_TYPE field set to “1” and is used to perform end waiting processing. Specifically, the command processing unit 102 inquires of the CPU 406 about the end status of the first position estimation processing 1005 subjected to a start instruction with the second command 1205. If the first position estimation processing 1005 is completed, the CPU 406 returns an ending notification to the command processing unit 102. The command processing unit 102 waits until receiving the ending notification from the CPU 406.

Thus, the first position estimation processing 1005 subjected to a start instruction with the second command 1205 is waited for ending with the fourth command 1210. Accordingly, during a period from when the command processing unit 102 processes the second command 1205 to when the command processing unit 102 processes the fourth command 1210, the command processing unit 102 and the CPU 406 perform processing in parallel with each other. This enables shortening the overall processing time as compared with the case of processing the first position estimation processing 1005 by the command processing unit 102.

The fifth command 1211 has a TYPE field set to “1” and a SUB_TYPE field set to “1” and is used to perform the association processing 1012. The fifth command 1211 has an SRC0 field, which is used to give a storage location of the first processing result 1006, an SRC1 field, which is used to give a storage location of the second processing result 1011, and an SRC2 field, which is used to give a storage location of the post-processing setting 1009. Accordingly, the SRC0 field, the SRC1 field, and the SRC2 field are set to the same address as that designated in the DST field set in the MSG field of the second command 1205, the same address as that designated in the DST field of the third command 1209, and the same address as that designated in the DST field of the first command 1204, respectively. The fifth command 1211 has a DST field which is set to indicate in what address of the output data retention unit 105 to store the third processing result 1013.

The sixth command 1212 has a TYPE field set to “2” and is thus used to perform output processing. The output processing is processing for outputting the first processing result 1006 stored in the output data retention unit 105 to an external unit. The sixth command 1212 has an SRC field, which is used to give a storage location of the first processing result 1006 serving as a target for outputting, set to the same address as that designated in the DST field of the MSG field of the second command 1205.

The seventh command 1213 has a TYPE field set to “2” and is thus used to perform output processing. The output processing is processing for outputting the second processing result 1011 stored in the output data retention unit 105 to an external unit. The seventh command 1213 has an SRC field, which is used to give a storage location of the second processing result 1011 serving as a target for outputting, set to the same address as that designated in the DST field of the third command 1209.

The eighth command 1214 has a TYPE field set to “2” and is thus used to perform output processing. The output processing is processing for outputting the third processing result 1013 stored in the output data retention unit 105 to an external unit. The eighth command 1214 has an SRC field, which is used to give a storage location of the third processing result 1013 serving as a target for outputting, set to the same address as that designated in the DST field of the fifth command 1211.

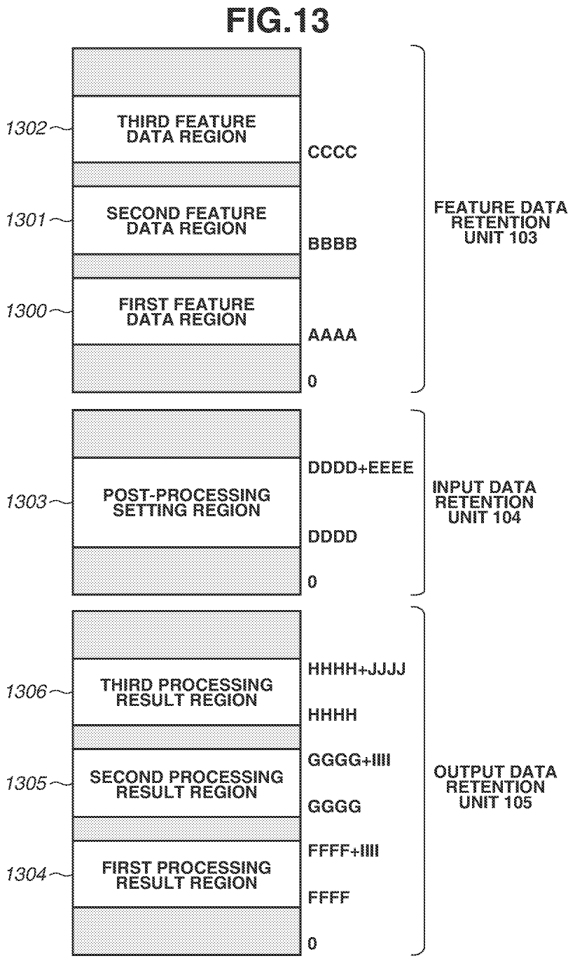

FIG. 13 illustrates a memory map which is used for the recognition processing unit 407 to perform processing with use of the parameters illustrated in FIG. 12. As with the first exemplary embodiment, the feature data retention unit 103, the input data retention unit 104, and the output data retention unit 105 are assigned the regions for respective pieces of data to be stored therein.

The feature data retention unit 103 is provided with a first feature data region 1300, a second feature data region 1301, and a third feature data region 1302, which are used to store the first feature data 1002, the second feature data 1004, and the third feature data 1008, respectively. According to the DST field of the first multiply-accumulate operation parameter 1200, the start address of the first feature data region 1300 becomes “AAAA”. According to the DST field of the second multiply-accumulate operation parameter 1201, the start address of the second feature data region 1301 becomes “BBBB”. According to the DST field of the third multiply-accumulate operation parameter 1206, the start address of the third feature data region 1302 becomes “CCCC”. In the second command 1205, which accesses the second feature data region 1301, “BBBB” is set to the corresponding field, i.e., the SRCO field of the MSG field. In the third command 1209, which accesses the third feature data region 1302, “CCCC” is set to the corresponding field, i.e., the SRCO field.

The input data retention unit 104 is provided with a post-processing setting region 1303, which is used to store the post-processing setting 1009. According to the DST field of the first command 1204, the start address of the post-processing setting region 1303 becomes “DDDD”. In the second command 1205, the third command 1209, and the fifth command 1211, which access the post-processing setting region 1303, “DDDD” is set to the respective corresponding fields.

The output data retention unit 105 is provided with a first processing result region 1304, a second processing result region 1305, and a third processing result region 1306, which are used to store the first processing result 1006, the second processing result 1011, and the third processing result 1013, respectively. According to the MSG field of the second command 1205, the start address of the first processing result region 1304 becomes “FFFF”. According to the DST field of the third command 1209, the start address of the second processing result region 1305 becomes “GGGG”. In the fifth command 1211, which refers to the first processing result region 1304 and the second processing result region 1305, “FFFF” and “GGGG” are set to the corresponding SRCO field and SRC1 field, respectively. Similarly, “FFFF” and “GGGG” are also set to the SRC fields of the sixth command 1212 and the seventh command 1213, respectively.

According to the DST field of the fifth command 1211, the start address of the third processing result region 1306 becomes “HHHH”. “HHHH” is set to the corresponding field, i.e., the SRC field, of the eighth command 1214, which refers to the third processing result region 1306.

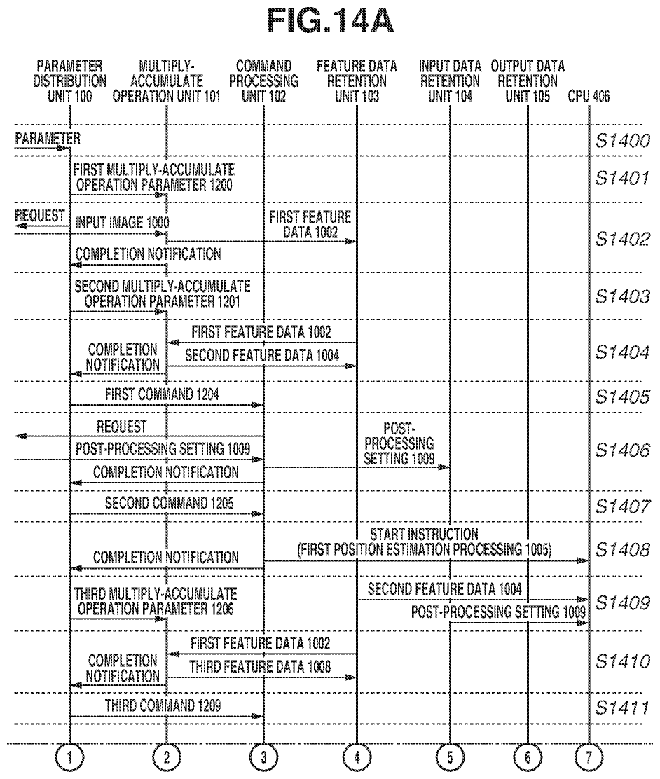

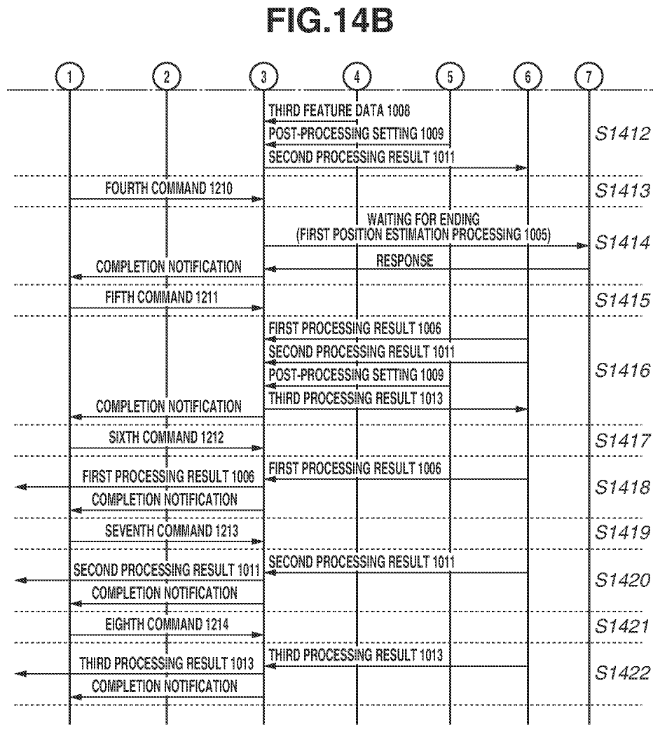

FIGS. 14A and 14B illustrate a sequence which the recognition processing unit 407 performs for processing with use of the parameters illustrated in FIG. 12. In the second exemplary embodiment, with respect to the second command 1205 to the fifth command 1211 illustrated in FIG. 12, the command processing unit 102 and the CPU 406 perform parallel processing. FIGS. 14A and 14B illustrate a sequence also including the operation of the CPU 406 in addition to the operations in the first exemplary embodiment illustrated in FIG. 9.

In step S1400, the parameter distribution unit 100 receives parameters from an external unit, and starts a series of recognition processing operations illustrated in FIG. 10. In step S1401, the parameter distribution unit 100 transmits the first multiply-accumulate operation parameter 1200 to the multiply-accumulate operation unit 101. In step S1402, the multiply-accumulate operation unit 101 starts processing of the first CNN 1001 according to the received first multiply-accumulate operation parameter 1200. Specifically, first, the multiply-accumulate operation unit 101 receives the input image 1000 from an external unit. Next, the multiply-accumulate operation unit 101 calculates the first feature data 1002 and stores the calculated first feature data 1002 in the feature data retention unit 103. Lastly, the multiply-accumulate operation unit 101 transmits a processing completion notification to the parameter distribution unit 100.

In step S1403, the parameter distribution unit 100 transmits the second multiply-accumulate operation parameter 1201 to the multiply-accumulate operation unit 101. In step S1404, the multiply-accumulate operation unit 101 starts processing of the second CNN 1003 according to the received second multiply-accumulate operation parameter 1201.

Specifically, first, the multiply-accumulate operation unit 101 receives the first feature data 1002 from the feature data retention unit 103. Next, the multiply-accumulate operation unit 101 calculates the second feature data 1004 and stores the calculated second feature data 1004 in the feature data retention unit 103. Lastly, the multiply-accumulate operation unit 101 transmits a processing completion notification to the parameter distribution unit 100.

In step S1405, the parameter distribution unit 100 starts transfer of the first post-processing parameter 1202. Specifically, the parameter distribution unit 100 transmits commands at two different times to the command processing unit 102 according to the setting of the LENGTH field of the first post-processing parameter header 1203. First, the parameter distribution unit 100 transmits the first command 1204. In step S1406, the command processing unit 102 starts the input processing according to the first command 1204. Specifically, first, the command processing unit 102 receives the post-processing setting 1009 from an external unit. Next, the command processing unit 102 stores the received post-processing setting 1009 in the input data retention unit 104. Lastly, the command processing unit 102 transmits a processing completion notification to the parameter distribution unit 100.

In step S1407, the parameter distribution unit 100 transmits the second command 1205 to the command processing unit 102. In step S1408, the command processing unit 102 transmits a start instruction for the first position estimation processing 1005 to the CPU 406 according to the second command 1205. Specifically, the command processing unit 102 sends the content of the MSG field of the second command 1205 to the CPU 406. The CPU 406 starts the first position estimation processing 1005 according to the received content of the MSG field.

In step S1409, the parameter distribution unit 100 transmits the third multiply-accumulate operation parameter 1206 to the command processing unit 102. On the other hand, the CPU 406 reads out the second feature data 1004 from the feature data retention unit 103 and reads out the post-processing setting 1009 from the input data retention unit 104. The CPU 406 refers to a specific channel of the second feature data 1004 and obtains the coordinates of a position the score of which is high.

In step S1410, the multiply-accumulate operation unit 101 starts processing of the third CNN 1007 according to the received third multiply-accumulate operation parameter 1206. Specifically, first, the multiply-accumulate operation unit 101 receives the first feature data 1002 from the feature data retention unit 103. Next, the multiply-accumulate operation unit 101 calculates the third feature data 1008 and stores the calculated third feature data 1008 in the feature data retention unit 103. Lastly, the multiply-accumulate operation unit 101 transmits a processing completion notification to the parameter distribution unit 100. On the other hand, the CPU 406 stores the coordinates obtained in step S1409 as the first processing result 1006 in the output data retention unit 105. Thus, the CPU 406 enters into the state of having completed the first position estimation processing 1005 subjected to a start instruction from the command processing unit 102 in step S1408.

In step S1411, the parameter distribution unit 100 starts transfer of the second post-processing parameter 1207. The parameter distribution unit 100 transmits commands at six different times to the command processing unit 102 according to the setting of the LENGTH field of the second post-processing parameter header 1208. First, the parameter distribution unit 100 transmits the third command 1209. In step S1412, the command processing unit 102 starts the second position estimation processing 1010 according to the third command 1209. Specifically, first, the command processing unit 102 reads out the third feature data 1008 from the feature data retention unit 103 and reads out the post-processing setting 1009 from the input data retention unit 104. Next, the command processing unit 102 refers to a specific channel of the third feature data 1008, obtains the coordinates of a position the score of which is high, and stores the obtained coordinates as the second processing result 1011 in the output data retention unit 105. lastly, the command processing unit 102 transmits a processing completion notification to the parameter distribution unit 100.

In step S1413, the parameter distribution unit 100 transmits the fourth command 1210 to the command processing unit 102. In step S1414, according to the fourth command 1210, the command processing unit 102 waits for ending of the first position estimation processing 1005 to be performed by the CPU 406. Specifically, first, the command processing unit 102 inquires of the CPU 406 about a completion status of the first position estimation processing 1005. The command processing unit 102 continues making an inquiry until receiving a completion notification from the CPU 406.

Furthermore, while, in the second exemplary embodiment, it is assumed that the CPU 406 completes the first position estimation processing 1005 in step S1410, it is to be noted that this is not preliminarily defined by parameters. Thus, the timing at which the CPU 406 completes the first position estimation processing 1005 varies within the range of step S1408 to step S1414 due to factors varying at the time of execution of, for example, the input image 1000.

If the first position estimation processing 1005 is completed, the CPU 406 returns an ending notification as a response to the inquiry to the command processing unit 102. Furthermore, while, in the second exemplary embodiment, a configuration in which the command processing unit 102 actively performs waiting for ending is employed, a configuration in which the CPU 406 actively issues an ending notification, such as a configuration in which the CPU 406 notifies the command processing unit 102 of the completion of the first position estimation processing 1005 with an interrupt, can be employed. Upon the completion of waiting for ending of the first position estimation processing 1005, the command processing unit 102 returns a completion notification to the parameter distribution unit 100.

In step S1415, the parameter distribution unit 100 transmits the fifth command 1211 to the command processing unit 102. In step S1416, the command processing unit 102 starts the association processing 1012 according to the fifth command 1211. Specifically, first, the command processing unit 102 reads out the first processing result 1006 and the second processing result 1011 from the output data retention unit 105 and reads out the post-processing setting 1009 from the input data retention unit 104. Next, the command processing unit 102 associates, with each other, a plurality of subjects included in the first processing result 1006 and the second processing result 1011, i.e., subjects estimated to be the same person with respect to the head portion and body portion of the person. The command processing unit 102 stores a result of the association as the third processing result 1013 in the output data retention unit 105. Lastly, the command processing unit 102 transmits a processing completion notification to the parameter distribution unit 100.

In step S1417, the parameter distribution unit 100 transmits the sixth command 1212 to the command processing unit 102. In step S1418, the command processing unit 102 starts output processing according to the sixth command 1212. Specifically, first, the command processing unit 102 reads out the first processing result 1006 from the output data retention unit 105. Next, the command processing unit 102 outputs the read-out first processing result 1006 to an external unit. Lastly, the command processing unit 102 transmits a processing completion notification to the parameter distribution unit 100.

In step S1419, the parameter distribution unit 100 transmits the seventh command 1213 to the command processing unit 102. In step S1420, the command processing unit 102 starts output processing according to the seventh command 1213. Specifically, first, the command processing unit 102 reads out the second processing result 1011 from the output data retention unit 105. Next, the command processing unit 102 outputs the read-out second processing result 1011 to an external unit. Lastly, the command processing unit 102 transmits a processing completion notification to the parameter distribution unit 100.

In step S1421, the parameter distribution unit 100 transmits the eighth command 1214 to the command processing unit 102. In step S1422, the command processing unit 102 starts output processing according to the eighth command 1214. Specifically, first, the command processing unit 102 reads out the third processing result 1013 from the output data retention unit 105. Next, the command processing unit 102 outputs the read-out third processing result 1013 to an external unit. Lastly, the command processing unit 102 transmits a processing completion notification to the parameter distribution unit 100.

As described above, giving the parameters illustrated in FIG. 12 enables the recognition processing unit 407 to perform a series of recognition processing operations illustrated in FIG. 10. Thus, the recognition processing unit 407 is able to perform recognition processing operations from when receiving the input image 1000 and the post-processing setting 1009 until returning the first processing result 1006, the second processing result 1011, and the third processing result 1013. Even in the second exemplary embodiment, as with the first exemplary embodiment, the recognition processing unit 407 becomes able to deal with different recognition processing operations without increasing the program size.

In the second exemplary embodiment, during a period from the time of step S1408 to the time of step S1414, the recognition processing unit 407 processes the third CNN 1007 and the second position estimation processing 1010 and the CPU 406 processes the first processing result 1006 in a parallel way. This enables speeding up of recognition processing operations subjected to parallel processing in the sequence definition using the parameters illustrated in FIG. 12.

In the second exemplary embodiment, the recognition processing unit 407 and the CPU 406 perform parallel processing, and the parameter distribution unit 100 plays the role of controlling the recognition processing unit 407 and the CPU 406. On the other hand, the command processing unit 102 instructs the CPU 406 to start processing and performs waiting for ending of the processing, and these sequences are defined by the parameters. Accordingly, a new configuration required for adding parallel processing is only adding step S1108 to step S1110 in the flowchart illustrated in FIG. 11 to the command processing unit 102. Moreover, in the case of changing, for example, the timing or the number of times of processing start and waiting for ending, only changing the parameters is required, so that it is possible to prevent an increase in the program size of the recognition processing unit 407 as a whole.

On the other hand, for example, in a case where the second position estimation processing 1010 tends to require larger processing time than the first position estimation processing 1005, permutating the sequential order of processing operations enables attaining speeding up. First, the third CNN 1007 is processed in advance of the second CNN 1003. The second CNN 1003 and the first position estimation processing 1005 are processed by the recognition processing unit 407 and the second position estimation processing 1010 is processed by the CPU 406. This can be implemented by switching around the second multiply-accumulate operation parameter 1201 and the third multiply-accumulate operation parameter 1206 and switching around the setting contents of the MSG field of the second command 1205 and the respective fields of the third command 1209.

In this way, in the data processing apparatus according to the second exemplary embodiment, it becomes possible to re-define a sequence of recognition processing operations corresponding to the purpose only by switching the sequential order of parameters. Even in this case, since it is not necessary to add a new configuration to the recognition processing unit 407, particularly, to the command processing unit 102, it is possible to deal with a sequence of different recognition processing operations while preventing or reducing an increase in the program size.

In the second exemplary embodiment, defining, with parameters, a sequence including not only a post-processing portion of recognition processing but also a multiply-accumulate operation portion thereof enables obtaining an advantageous effect different from that in the first exemplary embodiment, such as speeding up of recognition processing. This is implemented by a configuration in which the parameter distribution unit 100 receives parameters obtained by interconnecting a multiply-accumulate operation parameter and a post-processing parameter and determines the processing order of the multiply-accumulate operation unit 101 and the command processing unit 102 according to the alignment sequence of the parameters.

### Definition of Multiply-Accumulate Operation Portion

In the first and second exemplary embodiments, with recognition processing for an image taken as an example, the example of dealing with recognition processing including a CNN has been described. However, the data processing apparatus described above is applicable to overall recognition processing operations including not only a CNN but also any type of NN. For example, the first CNN 201 in the first exemplary embodiment can be replaced by a general multi-layer perceptron other than convolution operation.

### Definition of Post-Processing Portion

In the first and second exemplary embodiments, processing for obtaining a recognition result from the output of a neural network is processed as post-processing by the command processing unit 102, and the sequence for such processing is defined by a post-processing parameter.

However, processing which the command processing unit 102 performs does not need to be processing placed behind the NN. For example, a part of the NN arithmetic operation can be performed as processing by the command processing unit 102, or a portion corresponding to preprocessing of the NN to be next processed can be processed in advance by the command processing unit 102. In either case, new SUB_TYPE is defined for a command the TYPE field of which is “1” in the flowchart illustrated in FIG. 5. A required function is added to the command processing unit 102, and the added function is invoked by a command with the corresponding SUB_TYPE set therein and is then used.

### Configuration of Command Processing Unit 102

In the first and second exemplary embodiments, post-processing is divided into three types or four types of processing operations, and the sequence is defined as a sequence of commands corresponding to such processing operations. Then, the command processing unit 102 determines the type of a processing operation by the TYPE field of the command concerned, as illustrated in the flowcharts of FIG. 5 and FIG. 11.

However, the definition of the TYPE field illustrated in the flowcharts of FIG. 5 and FIG. 11 is merely an example, and commands used in the first and second exemplary embodiments can be integrated or divided, so that the distinction for the TYPE field and SUB_TYPE field can be given by different definitions. For example, a configuration in which input processing and output processing are aggregated into one TYPE and are distinguished by SUB_TYPE can be employed. Alternatively, position estimation processing can be divided into a group of finer processing operations and such finer processing operations can be added as new branches of SUB_TYPE to the branch with the TYPE field set to “1” and subsequent branches.

### Parallel Processing for Multiply-accumulate Operation Unit 101 and Command Processing Unit 102

In the first and second exemplary embodiments, the parameter distribution unit 100 allocates parameters to the multiply-accumulate operation unit 101 and the command processing unit 102 and causes the multiply-accumulate operation unit 101 and the command processing unit 102 to alternately operate.

However, a configuration in which the multiply-accumulate operation unit 101 and the command processing unit 102 operate in parallel with each other can be employed. For example, in the case of processing the parameters illustrated in FIG. 12, without waiting for the completion of processing of the second command 1205 by the command processing unit 102, the parameter distribution unit 100 can start transfer of the third multiply-accumulate operation parameter 1206 to the multiply-accumulate operation unit 101

In this case, for example, a field indicating whether the parameter distribution unit 100 performs waiting for an ending notification can be added to each command in the parameters illustrated in FIG. 12. In the second command 1205, the added field becomes “0” and all of the other fields become “1”. The parameter distribution unit 100 checks the added field of each command and performs waiting for an ending notification only if needed.

### Skipping by Parameter Distribution Unit 100

In the first and second exemplary embodiments, the parameter distribution unit 100 processes all of the multiply-accumulate operation parameters and post-processing parameters included in the parameters.

However, a configuration in which the parameter distribution unit 100 selectively processes only a part of the parameters depending on the status of recognition processing can be employed. For example, in a case where the position the score of which is high in the first position estimation processing 204 illustrated in FIG. 2 is not found in the first feature data 202, i.e., the position of the head portion of a person is not output, the execution of the first processing result 206 becomes unnecessary.

In this case, for example, a configuration in which, upon receiving an abnormal end notification from the command processing unit 102, the parameter distribution unit 100 skips transfer of the corresponding command can be added. The command processing unit 102 sends an abnormal end notification to the parameter distribution unit 100 when the first processing result 206 is vacant. The parameter distribution unit 100 receives the abnormal end notification and, without transferring the fourth command 706 to the command processing unit 102, advances to transfer of the next, fifth command 707.

### Implementation Form of Recognition Processing Unit 407

In the first and second exemplary embodiments, the recognition processing unit 407 has been described as hardware configuring a part of the data processing apparatus in each exemplary embodiment. However, for example, the entirety of the recognition processing unit 407 can be implemented as a program running on a CPU. In that case, the recognition processing unit 407 also includes the functions corresponding to the parameter distribution unit 100, the multiply-accumulate operation unit 101, and the command processing unit 102, and gives a sequence of recognition processing by the parameters such as those illustrated in FIG. 7 and FIG. 12.

Moreover, in the above-described exemplary embodiments, the case of processing convolution operation by hardware has been described. This can be processed by a processor such as a CPU, a graphics processing unit (GPU), or a digital signal processing unit (DSP).

Moreover, the present disclosure can be implemented by processing for providing a program for implementing one or more functions of the above-described exemplary embodiments to a system or apparatus via a network or a storage medium and causing one or more processors included in a computer of the system or apparatus to read out and execute the program.

Moreover, the present disclosure can be implemented by a circuit which implements one or more functions of the above-described exemplary embodiments (for example, an application specific integrated circuit (ASIC)).

While some exemplary embodiments of the present disclosure have been described above, the present disclosure is not limited to such exemplary embodiments and can be altered or modified in various manners within the scope of the gist of the present disclosure.

According to aspects of the present disclosure, in a data processing apparatus which performs processing of a plurality of types of neural networks, it becomes possible to perform a larger number of types of processing operations while preventing or reducing an increase in the program size or circuit size.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-092414filed Jun. 5, 2023, which is hereby incorporated by reference herein in its entirety.

What is claimed is:

1. A data processing apparatus comprising:
a multiply-accumulate operation unit configured to perform multiply-accumulate operation on data based on a given multiply-accumulate operation parameter;
an arithmetic operation result retention unit configured to retain an arithmetic operation result obtained by the multiply-accumulate operation unit;
a command processing unit configured to, based on a given command, perform processing defined by the command on the arithmetic operation result retained by the arithmetic operation result retention unit; and
a distribution unit configured to receive a parameter sequence obtained by a combination of the multiply-accumulate operation parameter and the command and configured to, based on a content and sequential order of the combination, give the multiply-accumulate operation parameter to the multiply-accumulate operation unit and give the command to the command processing unit.

2. The data processing apparatus according to claim 1,
wherein the distribution unit gives the multiply-accumulate operation parameter and the command to the multiply-accumulate operation unit and the command processing unit, and
wherein the multiply-accumulate operation unit and the command processing unit perform processing in an order in which the distribution unit has given the multiply-accumulate operation parameter and the command.

3. The data processing apparatus according to claim 1, wherein the multiply-accumulate operation unit performs multiply-accumulate operation in a neural network based on a content of the multiply-accumulate operation parameter.

4. The data processing apparatus according to claim 1, further comprising an input data retention unit configured to retain input data which the command processing unit uses to perform processing,
wherein, based on a content of the command, the command processing unit performs processing for storing input data received from an external unit in the input data retention unit.

5. The data processing apparatus according to claim 1, further comprising an output data retention unit configured to retain output data which is obtained by processing performed by the command processing unit,
wherein, based on a content of the command, the command processing unit performs processing for outputting output data retained by the output data retention unit to an external unit.

6. The data processing apparatus according to claim 1, further comprising:
an input data retention unit configured to retain input data which the command processing unit uses to perform processing; and
an output data retention unit configured to retain output data which is obtained by processing performed by the command processing unit,
wherein, based on a content of the command, the command processing unit performs processing while referring to data which the arithmetic operation result retention unit and the input data retention unit retain and performs processing for storing data obtained by the performed processing in the output data retention unit.

7. The data processing apparatus according to claim 1, further comprising an arithmetic operation processing unit configured to perform any one of processing operations which the command processing unit performs based on a content of the command,
wherein, based on the content of the command, the command processing unit instructs the arithmetic operation processing unit to start processing and waits for completion of the processing performed by the arithmetic operation processing unit.

8. The data processing apparatus according to claim 1, wherein, based on a content of the command, the distribution unit determines whether to wait for completion of the processing performed by the command processing unit.

9. The data processing apparatus according to claim 1, wherein the multiply-accumulate operation unit performs the multiply-accumulate operation in parallel with the processing defined by the command which the command processing unit performs.

10. The data processing apparatus according to claim 1,
wherein the command processing unit transmits, to the distribution unit, a notification of a result of processing which the command processing unit has performed based on the command, and
wherein, based on the notification transmitted from the command processing unit, the distribution unit switches the command to be transmitted to the command processing unit.

11. The data processing apparatus according to claim 1, wherein, based on the multiply-accumulate operation parameter, the multiply-accumulate operation unit performs multiply-accumulate operation in recognition processing to calculate feature data.

12. The data processing apparatus according to claim 11, wherein, based on the command, the command processing unit calculates a result of the recognition processing from the feature data.

13. A data processing method for a data processing apparatus including a multiply-accumulate operation unit, an arithmetic operation result retention unit, and a command processing unit, the data processing method comprising:
receiving a parameter sequence obtained by a combination of a multiply-accumulate operation parameter and a command and, based on a content and sequential order of the combination, giving the multiply-accumulate operation parameter to the multiply-accumulate operation unit and giving the command to the command processing unit;
causing the multiply-accumulate operation unit to perform multiply-accumulate operation on data based on a given multiply-accumulate operation parameter;
storing a result of the multiply-accumulate operation in the arithmetic operation result retention unit; and
causing the command processing unit to, based on a given command, perform processing defined by the command on the arithmetic operation result retained by the arithmetic operation result retention unit.

14. A non-transitory computer-readable storage medium storing computer-executable instructions that, when executed by a computer, cause the computer to perform a data processing method for a data processing apparatus including a multiply-accumulate operation unit, an arithmetic operation result retention unit, and a command processing unit, the data processing method comprising:
receiving a parameter sequence obtained by a combination of a multiply-accumulate operation parameter and a command and, based on a content and sequential order of the combination, giving the multiply-accumulate operation parameter to the multiply-accumulate operation unit and giving the command to the command processing unit;
causing the multiply-accumulate operation unit to perform multiply-accumulate operation on data based on a given multiply-accumulate operation parameter;
storing a result of the multiply-accumulate operation in the arithmetic operation result retention unit; and
causing the command processing unit to, based on a given command, perform processing defined by the command on the arithmetic operation result retained by the arithmetic operation result retention unit.
